(19) United States
(12) Patent Application Publication
(10) Pub. No.: US 2026/0244522 A1
(43) Pub. Date: Aug. 20, 2026

(54) HANDLING ADDRESSING ERRORS IN AN INPUT/OUTPUT MEMORY MANAGEMENT UNIT

(71) Applicant: INTERNATIONAL BUSINESS MACHINES CORPORATION, ARMONK, NY (US)

(72) Inventors: LUKE HOPKINS, Peterborough, NH (US); Michael James Becht, Poughkeepsie, NY (US); Sascha Junghans, Ammerbuch (DE); Raymond Wong, Hopewell Junction, NY (US)

(21) Appl. No.: 19/056,883

(22) Filed: Feb. 19, 2025

(51) Int. Cl. G06F 11/07

(52) U.S. Cl. CPC G06F 11/0751; G06F 11/0745

(57) ABSTRACT

A device driver programs an IOMMU to receive a list of addresses and additional information associated with an I/O operation. The device driver performs an assignment of page table entries for the operation. The IOMMU detects an error in any of the page accesses defined to be part of the operation, stops processing of the operation and writes the error data starting at the first PTE index of the operation. The device driver determines the first index of the operation using a power of 2 alignment of the set of PTEs associated with the operation and a log2 alignment field in each PTE.

### FIELD OF THE INVENTION

The disclosure relates generally to the handling of addressing errors in an input/output memory management unit (IOMMU) operations. The invention relates particularly to limiting any affect addressing errors have upon system performance and availability.

### BACKGROUND

Input/output (I/O) operations are fundamental to the functioning of computer systems, allowing data transfer between processors, memory, and peripheral devices. As computer architectures have grown more complex, efficient management of I/O operations has become increasingly important for system performance and reliability.

IOMMUs, (I/O memory management units) have been developed to facilitate I/O operations by providing address translation and memory protection services. IOMMUs act as a bridge between I/O devices and system memory, translating virtual addresses used by devices into physical addresses in memory. This allows I/O devices to use virtual addressing, simplifying device drivers and improving system security.

In modern computer systems, multiple I/O operations may be in progress simultaneously within an IOMMU. Each operation typically involves a series of memory accesses, with the IOMMU translating addresses and checking permissions for each access. This concurrent processing of multiple operations allows for improved system throughput and responsiveness.

As computer systems continue to evolve, with increasing demands for performance, reliability, and security, there is an ongoing need for improved techniques in I/O management and error handling. Enhancements in these areas can contribute to more robust and efficient computer architectures across a wide range of applications.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable automated responses to I/O transactions.

In some aspects, the techniques described herein relate to a computer implemented method for responding to input/output transaction errors, the method including: receiving an I/O operation, assigning page table entries, or page table elements (PTEs) to the I/O operation; receiving device DMA transactions (PCIe or otherwise) causing the IOMMU to handle requests for memory transfers which may fail; receiving error data for the failed memory transfer; stopping processing of the PTE associated with the failed memory transfer; writing the error data to a first PTE of the I/O operation; and sending a failed completion notification for the I/O operation.

In some aspects, the techniques described herein relate to a computer program product for responding to input/output transaction errors, the computer program product including one or more computer readable storage media and collectively stored program instructions on the one or more computer readable storage media, the stored program instructions which, when executed, cause one or more computer systems to execute a method including: receiving an I/O operation, assigning page table entries (PTEs) to the operation;; Receiving device DMA transactions (PCIe or otherwise) causing the IOMMU hardware to handle requests for memory transfers by processing PTEs of the I/O operation, one or more of which may fail; receiving error data for the failed PTE; stopping processing of the PTE; writing the error data to a first PTE of the I/O operation; and sending a failed completion notification for the I/O operation. In one embodiment, the method proceeds through the execution of program instructions by a processor interacting with an adapter and the storage system.

In some aspects, the techniques described herein relate to a computer system for responding to input/output transaction errors, the computer system including: one or more computer processors; one or more computer readable storage media; and stored program instructions on the one or more computer readable storage media for execution by the one or more computer processors, the stored program instructions which, when executed, cause the one or more computer processors to execute a method including: receiving an I/O operation, assigning page table entries, or page table elements (PTEs) to the I/O operation; receiving device DMA transactions (PCIe or otherwise) causing the IOMMU to handle requests for memory transfers by processing a PTE of a I/O operation, which may fail; receiving error data for the failed PTE; stopping processing of the PTE; writing the error data to a first PTE of the I/O operation; and sending a failed completion notification for the I/O operation.

Aspects of the invention disclose methods, systems and computer readable media associated with handling I/O transaction errors in a manner which reduces the impact failing I/O transactions have upon other I/O operations which are concurrently processing. The invention provides details on failed transactions while promoting the availability of limited system resources.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

Errors can occur during I/O operations, such as when an incorrect address or access key is specified. Detecting and handling such errors efficiently, without disrupting other ongoing operations, presents challenges for IOMMU design. Traditional error handling approaches may result in the failure of multiple operations or require extensive hardware and software overhead.

Memory checking may include detecting an access failure by an adapter because of a security restriction, then this can be reported to the system software using disclosed methods. Zone limit, keys, and range checking are a form of security enforcement, but the access restrictions don’t have to be limited to those, they may include other checks that can be reported in the same way.

It is possible that the host program specifies an incorrect address or key for data in one or more of the pages of memory being accessed in an I/O operation. The IOMMU hardware will detect the error as data is being transferred between an attached peripheral adapter (such as a PCIe adapter) and the host system. The I/O transaction needs to be terminated with an error status specifying the location of the first incorrect page, and the type of error that occurred (key violation, invalid address, or other error type).

In conventional systems other I/O operations that are in progress in an IOMMU may be affected by a failing operation, whether or not they are associated with the same PCIe interface, virtual or physical function. In existing IOMMUs an error in a single I/O may cause the failure of other I/O operations that are in progress. Multiple I/O operations may fail simultaneously. Disclosed embodiments accommodate the failure of one or more operations with no effect on other ongoing operations and provides details of the operations’ failures. Embodiments provide flexibility in the maximum size of the I/O operations and there is no need for implementing additional queues or other data structures for use by hardware and firmware.

Aspects of the present invention relate generally to IOMMU systems and, more particularly, to handling I/O addressing errors in such systems. In embodiments, the error handling system handle addressing errors by receiving an I/O operation, assigning page table entries (PTEs) to the operation; dividing the PTEs into a plurality of operations; processing PTEs of the I/O operation including performing page translations and memory operations when transactions are received from the attached device (typically read and write DMA operations driven by a PCIe adapter),; receiving error data from a storage subsystem for a PCIe transaction associated with the PTE; stopping processing of the PTE; and writing the error data to a first PTE assigned to the operation. In this manner, implementations of the invention handle addressing errors of the IOMMU without the disruption of stopping IO operations unrelated to the addressing errors.

In accordance with aspects of the invention there is a method for automatically handling addressing errors in IOMMU systems, the method including: receiving an I/O operation, assigning page table entries (PTEs) to the operation; dividing the PTEs into a plurality of operations; processing PTEs including performing page translations and memory operations when transactions are received from the attached device (typically read and write DMA operations driven by a PCIe adapter),; receiving error data from a storage subsystem for a PCIe transaction associated with the PTE; stopping processing of the PTE; and writing the error data to a first PTE assigned to the first operation.

Aspects of the invention provide an improvement in the technical field of IOMMU exception handling. Conventional IOMMU functionality may lead to multiple I/O operations stopping due to an unrelated I/O addressing errors as the IOMMU cannot differentiate between the operation related to the addressing error and other concurrent operations. A transaction failure may cause numerous other operations to fail as well. By receiving an I/O operation, assigning page table entries, or page table elements (PTEs) to the I/O operation; receiving device DMA transactions (PCIe or otherwise) causing the IOMMU to handle requests for memory transfers by processing a PTEs of an operation which may fail; receiving error data for the failed PTE; stopping processing of the PTE; writing the error data to a first PTE of the first operation; and sending a completion notification for the operation, disclosed embodiments improve IOMMU operations and overall system resource availability as fewer resources are made unavailable due to I/O transaction failures.

Aspects of the invention also provide an improvement to computer functionality. In particular, implementations of the invention are directed to a specific improvement to the way IOMMU systems operate, embodied in the division of I/O page table entries into multiple I/O operations such that in the case of a addressing failure, it is only necessary to stop the operation containing the page table entry with the error and not multiple other operations as well. In this manner, embodiments of the invention reduce the effects of transaction failures upon system resource availability.

In an embodiment, one or more components of the system can employ hardware and/or software to solve problems that are highly technical in nature (e.g., receiving an I/O operation, assigning page table entries, or page table elements (PTEs) to the I/O operation; receiving device DMA transactions (PCIe or otherwise) causing the IOMMU to handle requests for memory transfers by processing a PTE of a first operation which may fail; receiving error data for the failed PTE; stopping processing of the PTE; writing the error data to a first PTE of the first operation; and sending a completion failure notification for the operation, etc.). These solutions are not abstract and cannot be performed as a set of mental acts by a human due to the processing capabilities needed to facilitate stopping the processing of a failed PTE, for example. Further, some of the processes performed may be performed by a specialized computer for carrying out defined tasks related to memory operations. For example, a specialized computer can be employed to carry out tasks related to IOMMU controls or the like.

In one embodiment, a computer implemented method responds to input/output transaction addressing errors. The method includes an IOMMU receives an I/O operation from a host program executing on the system and assigns page table entries to the I/O operation. Each PTE includes a start address, a length, and a storage key. After validation using the address and key, the IOMMU maps virtual device memory addresses to physical system memory addresses to enable the movement of data into and out of memory as required by the host program. The PTEs may include errors, erroneous addresses or storage keys may be provided by the host system. Such errors lead to a failure of the requested I/O operation and error information must be provided back to the host program.

In this embodiment, the method assigns page table entries into to the I/O operations. The method assigns each such I/O operation a set of PTEs where the total number of PTEs in each set is aligned to a power of two index (e.g., 2², 2³, 2⁴, 2⁵, etc.) such that the alignment is greater than or equal to the size of the I/O operation. The total number of PTEs assigned to an I/O operation must be large enough to accommodate the data transfer size and the maximum amount of error information that needs to be written. For example, if an I/O request comes in for a 7KB transfer, that uses a 4K page size, the system would need two-page table elements, the system would allocate two entries in the space of leaf nodes on an index which is divisible by 2. If a 13KB I/O transfer request came in, the system would allocate 4 PTEs on a boundary of 4, etc. This may be based on an MTU (maximum transmission unit), or buffer size for buffers that are filled asynchronously, as in the case for receive data coming off a LAN from a full duplex networking adapter. So, the system may be dividing blocks of received data and transferring the data to the host in those block-sized-units, in which case the system would choose a fixed number equal to the buffer/block size (which would typically be a power of 2).

Embodiments cannot transfer anything requiring more page table entries than can be indexed, or that have been allocated. In one embodiment, methods base the maximum size on the maximum number of page table entries that can be organized into one operation unit. In one embodiment, the method bases the number of PTEs allocated to an I/O operation (or buffer) to the maximum of the number of pages required for the operation and the number of PTEs required for the reporting of error information. This is to allow for writing more than one PTE of error information. The embodiment adds an additional requirement for alignment. An allocated unit has to be power of 2 aligned. The maximum number of PTEs available and correctly aligned according to the required size of the operation limit the largest possible I/O transaction. In an embodiment using a fixed maximum number of PTEs that would limit the maximum I/O size, which for one example is4 MB.

The method assigns each PTE of each operation an index. The method assigns the first PTE of an I/O operation an index value which is a power of two aligned to the maximum number of PTEs assigned to the I/O operation. As an example, the index for the first PTE of an I/O operation having a total of 16 PTEs would be a multiple of 16. The index of each succeeding PTE of that I/O operation would proceed sequentially from the value of the index of the first PTE. The index values are assigned sequentially to the PTEs of each set of contiguous PTEs assigned to an operation.

In this embodiment, the method further assigns a value equal to the log2 equivalent of the total number of PTEs of the I/O operation. For the example I/O operation requiring 9-16 PTEs, the method assigns a log2 value of 4 to an alignment field for each PTE of the I/O operation.

In one embodiment, the method proceeds to process each PTE of each operation, validating the address and key of each PTE. When a failure occurs in the processing due to an invalid address, key, or other failure, that failure will be associated with a specific PTE of the operation. The method then checks the value of the size field containing the log2 alignment value for the I/O operation, and then identifies the first PTE of the operation using the log2 value and the PTE index values. For the example, for a failure in the I/O operation having a log2 value of 4, the method looks for a PTE having an index with a value which is a multiple of 16, as the first PTE of the I/O operation where all of the PTEs for the I/O operation are allocated contiguously. Embodiments of the invention compute the index of the first PTE of the operation where the error information will be written, the embodiments takes the log2 alignment field of the failing PTE (which in this example is 4 indicating an index alignment of 16) and masks off the low order 4 bits of the index of the PTE associated with the failing operation (the failing PTE) This describes one embodiment, the method of which uses a mask to select the bits of the address of the failed PTE which identify the first PTE of the operation.

In one embodiment, the host system hardware detects some kind of access failure. For example, system storage may be keyed (on a page basis). In one embodiment, a key could be a 4-bit quantity. If the provided key value on an access request by an adapter doesn’t match what was assigned to the page by the OS, a key error occurs and access to the page is rejected. In this embodiment, the method also range checks the addresses as part of a process called zone relocation. For any address which falls outside of the range, the system generates an invalid address error. This is the information that is written into the aligned (designated PTE), specifically the type of the error (key or address), and the address and key that violated the check.

In one embodiment, when the failure occurs, the method continues, receiving error data from the IOMMU indicating the incorrect memory address which triggered the error, failed zone/key information referenced in the memory operation, and the reason for the failure or the type of error (invalid address, key error) as well as additional available information associated with the error. The method then stops the processing of the I/O operation having the erroneous PTE. Processing of all other I/O operations continues unaffected by the error and stoppage of I/O processing for the affected operation. In this embodiment, the method writes the received error data to the first PTE of the I/O operation and adds a “disable” flag to a field of the first PTE of the operation.

For an error in a “read” operation initiated by an I/O adapter, the method sends an Unsupported Request (UR) frame from the IOMMU to the PCIe adapter which passes a DMA error indication along to the host software making the erroneous request.

In one embodiment, the method sends a notice to the PCIe adapter that the I/O operation has completed after stopping the processing. The notice of completion triggers system device drivers to check the first PTE of the complete operation to determine if the disable flag of the PTE has been set.

Systems perform operations at the beginning of a transaction (prior to feeding virtual addresses to an adapter) include choosing the number of page translation entries required (and also ensuring power of 2 alignment), then configuring each entry with the appropriate translated address and log2 alignment value. This could be performed by an operating system running on a CPU, or it could be performed by firmware (such as in the case with the I/O subsystem in IBM Z17). This is typically not performed by application software. (Note: the terms: IBM, and Z17, may be subject to trademark rights in various jurisdictions throughout the world and are used here only in reference to the products or services properly denominated by the marks to the extent that such trademark rights may exist.)

At the completion of an operation a device driver would check the first PTE in the operation group to see if there was a failure, and if so, capture the address associated with the failure and report that to a higher-level layer in the operating system so that recovery actions can be taken including the notification of any affected software applications. So, the device driver that does this step may be part of the operating system running on the CPU, or it may be firmware running in an embedded system.

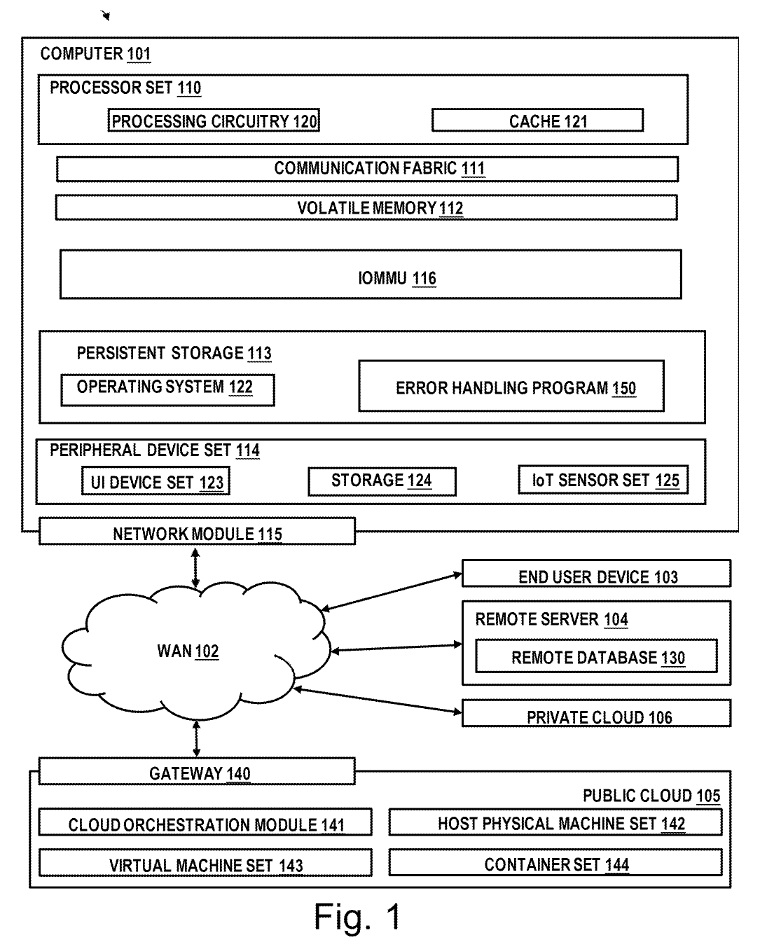

As shown in FIG. 1, computing environment 100 contains an example of an environment for the execution of at least some of the computer code involved in performing the inventive methods, such as handling and responding to I/O transaction errors 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), Input/output memory management unit 116 between the peripheral device 114 persistent storage 113, and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet, using for example, fiber channel or ethernet connections. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

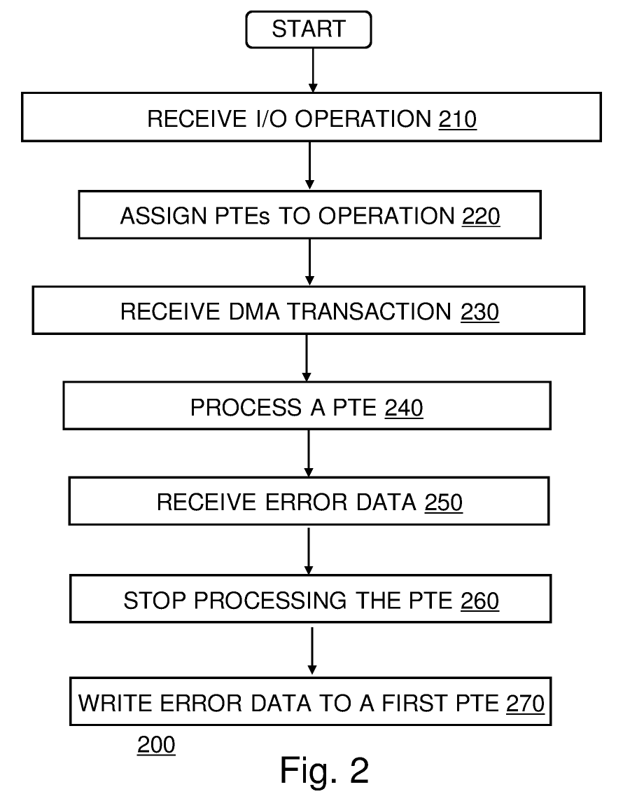

FIG. 2 provides a flowchart 200, illustrating exemplary activities associated with the practice of the disclosure. After program start at block 210, the system receives I/O transaction details in the form of address lists from a host program which are then converted to page table entries. Each page table entry includes memory address, a power of 2 alignment field, and a zone or storage key for validation.

At step 220, the method assigns a set of PTEs to the I/O operation. The set of PTEs includes a number of PTEs which is divisible by a power of 2, for example, 2, 4, 8, 16, etc., which is large enough to encompass the total set of PTEs needed to describe the pages of the I/O operation. The method assigns a sequential index value to each PTE of each set of contiguous PTEs of the I/O operation. For example, the first PTE of a set of PTEs of an operation having a total of 9-16 PTEs would have an index that is a multiple of 16. The method also assigns an alignment field value to each PTE of each set of PTEs of an operation. The alignment field value is defined as the log2 of the total number of PTEs of the set of PTEs of the operation. For example, the size field value for each PTE of a set of PTEs with 16 PTEs would be 4.

At step 230, the method receives a DMA or other memory access transaction including PCIe or bus transactions. At step 240, the IOMMU processes the individual PTEs of an operation when the received DMA transactions occur (or other bus transactions). When an addressing or storage key failure occurs, that failure is associated with, or due to the details of an individual PTE. Error data including any incorrect address data or incorrect storage keys are received by the IOMMU at step 250. At step 260, the IOMMU stops the processing of the PTEs of the set of PTEs of the operation which includes the error generating PTE. Processing of other PTEs of other operations continues. In one embodiment, the method stops the processing of the failed PTE. In an alternative embodiment, the method stops the processing of the entire I/O operation which includes the failed PTE. In either of these embodiments, the method continues the processing of other I/O operations which do not include failed PTEs.

At step 270, the method identifies the first PTE of the operation generating the error. The method utilizes the size field value to determine the index value of the first PTE of the operation. For an operation having 16 PTEs the size field value of 4 indicates that the first PTE of the operation has a value which is a multiple of 16. The method then overwrites the first PTE of the set of PTEs of the I/O operation with new data including the incorrect address, if any, the provided storage key, a zone identifier the defines the virtualization assignment, and an error code indicating the type of the error. The method further sets a disable flag for the PTE using a field of the PTE. The error data may comprise more data than the available space provided by the first PTE. In such cases, the method will continue to write error data to subsequent PTEs after the first PTE until all error data has been written.

The method then provides the error data to the requesting host program. For read requests, the method send a UR frame to the adapter which then will raise a DMA failure indication to the host device driver. For write requests by the adapter, the adapter sends a DMA completion notification to the host device driver causing the host to read the first PTE of the completed operation. Reading the first PTE notifies the host that a disable flag has been set for the PTE. The host software then responds appropriately to the notification of the disable flag for the PTE generating the error.

Example 1: In a data center environment, the IOMMU may handle I/O operations for multiple virtual machines running on a single physical server. If one virtual machine attempts an invalid memory access, the invention allows the IOMMU to isolate the error to that specific operation without affecting I/O operations for other virtual machines, maintaining overall system performance and stability.

In Example 1, a data center environment may implement an IOMMU to handle I/O operations for multiple virtual machines running on a single physical server. The IOMMU may receive an I/O operation and assign page table entries (PTEs) from one of the virtual machines to the I/O operation. Each PTE may include information such as a start address, length, and storage key.

The IOMMU PTEs for each I/O operation may be assigned as a power of two number of PTEs. For instance, if a virtual machine requests a 7KB transfer, the IOMMU may allocate two PTEs, while a 13KB transfer request may result in the allocation of 4 PTEs.

The IOMMU may then begin processing a PTE of a first operation. During this processing, the IOMMU may validate the address and key of the PTE. If the virtual machine attempts an invalid memory access, the IOMMU may receive error data for the PTE. This error data may include information about the incorrect memory address, failed zone/key information, and the reason for the failure.

Upon receiving the error data, the IOMMU may stop processing of the PTE. This stoppage may be limited to the specific operation containing the erroneous PTE, allowing I/O operations for other virtual machines to continue unaffected.

The IOMMU may then write the error data to a first PTE of the first operation. In some cases, the first page table element of the first operation may include an index aligned to the number of PTEs included in the operation. The PTE may also comprise a field representing the number of PTEs in the operation, which may be used to identify the first PTE of the first operation.

The error data written to the first PTE may comprise a disable flag, an address of the error, and an error code. This information may allow the system to identify and respond to the specific error that occurred. The error data may comprise more data than the available space provided by the first PTE. In such cases, the method will continue to write error data to subsequent PTEs after the first PTE until all error data has been written.

After writing the error data, the IOMMU may send a completion notification for the operation. This notification may trigger system device drivers to check the first PTE of the completed operation to determine if the disable flag has been set.

In some instances, the IOMMU may also send an unsupported request (UR) frame. For example, if the error occurred during a "read" operation, the IOMMU may send a UR frame to the PCIe adapter, which may then pass it along to the host software that made the erroneous request.

By implementing this method, the IOMMU may isolate the error to the specific operation of the virtual machine that attempted the invalid memory access. This isolation may help maintain overall system performance and stability by allowing I/O operations for other virtual machines to continue unaffected.

Example 2: In a high-performance computing cluster processing large datasets, the IOMMU may manage data transfers between compute nodes and storage systems. If a node attempts to access memory outside its allocated range, the invention enables the IOMMU to quickly identify and report the error while allowing other nodes to continue their operations uninterrupted.

In Example 2, a high-performance computing cluster may implement an IOMMU to manage data transfers between compute nodes and storage systems. The IOMMU may receive an I/O operation and assign page table entries (PTEs) from one of the compute nodes to the I/O operation. Each PTE may include information such as a start address, length, and storage key.

The IOMMU PTEs for each I/O operation may be assigned as a power of two number of PTEs. For instance, if a compute node requests a large data transfer, the IOMMU may allocate an appropriate number of PTEs based on the size of the transfer.

The IOMMU may then begin processing a PTE of a first operation. During this processing, the IOMMU may validate the address and key of the PTE. If a compute node attempts to access memory outside its allocated range, the IOMMU may receive error data for the PTE. This error data may include information about the incorrect memory address, failed zone/key information, and the reason for the failure.

Upon receiving the error data, the IOMMU may stop processing of the PTE. This stoppage may be limited to the specific operation containing the erroneous PTE, allowing data transfer operations for other compute nodes to continue unaffected.

The IOMMU may then write the error data to a first PTE of the first operation. In some cases, the first page table element of the first operation may include an index aligned to the number of PTEs included in the operation. The PTE may also comprise a field representing the number of PTEs in the operation, which may be used to identify the first PTE of the first operation.

The error data written to the first PTE may comprise a disable flag, an address of the error, and an error code. This information may allow the system to identify and respond to the specific error that occurred. The error data may comprise more data than the available space provided by the first PTE. In such cases, the method will continue to write error data to subsequent PTEs after the first PTE until all error data has been written.

After writing the error data, the IOMMU may send a completion notification for the operation. This notification may trigger system device drivers to check the first PTE of the completed operation to determine if the disable flag has been set.

In some instances, the IOMMU may also send an unsupported request (UR) frame. For example, if the error occurred during a "read" operation, the IOMMU may send a UR frame to the PCIe adapter, which may then pass it along to the host software that made the erroneous request.

By implementing this method, the IOMMU may quickly identify and report the error while allowing other nodes in the high-performance computing cluster to continue their operations uninterrupted. This approach may help maintain overall cluster performance and stability. Even if one compute node experiences a memory access error, the impact may be contained, and other nodes in the cluster may continue their operations without experiencing any degradation in performance or data processing capabilities.

The system may also implement logging and monitoring mechanisms to track these isolated errors across the cluster. This data may be used for performance optimization, workload balancing, or identifying potential issues in the dataset distribution or node allocation strategies.

This approach may help maintain overall cluster performance and stability in the HPC environment. Even if one compute node experiences a memory access error, the impact may be contained, and other nodes in the cluster may continue their operations without experiencing any degradation in performance or data processing capabilities.

The system may also implement logging and monitoring mechanisms to track these isolated errors across the cluster. This data may be used for performance optimization, workload balancing, or identifying potential issues in the dataset distribution or node allocation strategies.

Example 3: In an embedded system for an autonomous vehicle, the IOMMU may coordinate data flow between various sensors, the central processing unit, and control systems. If a malfunctioning sensor attempts an invalid memory access, the invention allows the IOMMU to contain the error and provide detailed diagnostic information without compromising the real-time performance of critical vehicle control systems.

Example 3: In an embedded system for an autonomous vehicle, the IOMMU may coordinate data flow between various sensors, the central processing unit, and control systems. If a malfunctioning sensor attempts an invalid memory access, the invention allows the IOMMU to contain the error and provide detailed diagnostic information without compromising the real-time performance of critical vehicle control systems.

Example 4: In a network security appliance inspecting high-volume traffic, the IOMMU may manage data transfers between network interfaces and analysis engines. If a software bug causes an invalid memory access in one analysis module, the invention enables the IOMMU to isolate the error and provide debugging information while allowing other traffic analysis to proceed unaffected.

It is to be understood that although this disclosure includes a description on cloud computing, implementation of the teachings recited herein are not limited to a cloud computing environment. Rather, embodiments of the present invention are capable of being implemented in conjunction with any other type of computing environment now known or later developed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, or media, as those terms are used in the present disclosure, explicitly excludes storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage medium or device as transitory because the data is not transitory while it is stored.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to "one embodiment", "an embodiment", "an example embodiment", etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for responding to input/output transaction errors, the method comprising:
receiving an I/O operation;
assigning page table entries / elements (PTEs) to the I/O operation;
processing a PTE of a first operation;
receiving error data for the PTE;
stopping processing of the PTE;
writing the error data to a first PTE of the first operation; and
sending a completion notification for the operation.

2. The computer implemented method according to claim 1, wherein each I/O operation is assigned a power of two number of PTEs.

3. The computer implemented method according to claim 1, wherein the first page table element of the first operation, includes an index aligned to a number of PTEs included in the operation.

4. The computer implemented method according to claim 1, wherein the PTE comprises a field representing a number of PTEs in the operation.

5. The computer implemented method according to claim 4, further comprising identifying the first PTE of the first operation according to the field of the PTE.

6. The computer implemented method according to claim 1, further comprising sending an unsupported request frame.

7. The computer implemented method according to claim 1, wherein the error data comprises a disable flag, an address of the error, and an error code.

8. A computer program product for responding to input/output transaction errors, the computer program product comprising one or more computer readable storage media and collectively stored program instructions on the one or more computer readable storage media, the stored program instructions which, when executed, cause one or more computer systems to execute a method comprising:
receiving an I/O operation;
assigning page table entries (PTEs) to the I/O operation;
processing a PTE of the I/O operation;
receiving error data for the PTE;
stopping processing of the PTE;
writing the error data to a first PTE of the I/O operation; and
sending a completion notification for the I/O operation.

9. The computer program product according to claim 8, wherein each I/O operation is assigned a power of two number of PTEs.

10. The computer program product according to claim 8, wherein the first page table element of the first operation, includes an index aligned to a number of PTEs included in the operation.

11. The computer program product according to claim 8, wherein the PTE comprises a field representing a number of PTEs in the operation.

12. The computer program product according to claim 11, further comprising identifying the first PTE of the first operation according to the field of the PTE.

13. The computer program product according to claim 8, further comprising sending an unsupported request frame.

14. The computer program product according to claim 8, wherein the error data comprises a disable flag, an address of the error, and an error code.

15. A computer system for responding to input/output transaction errors, the computer system comprising:
one or more computer processors;
one or more computer readable storage media; and
stored program instructions on the one or more computer readable storage media for execution by the one or more computer processors, the stored program instructions which, when executed, cause the one or more computer processors to execute a method comprising:
receiving an I/O operation;
assigning page table entries (PTEs) to the I/O operation;
processing a PTE of the I/O operation;
receiving error data for the PTE;
stopping processing of the PTE;
writing the error data to a first PTE of the I/O operation; and
sending a completion notification for the operation.

16. The computer system according to claim 15, wherein each I/O operation is assigned a power of two number of PTEs.

17. The computer system according to claim 15, wherein the first page table element of the first operation, includes an index aligned to a number of PTEs included in the operation.

18. The computer system according to claim 15, wherein the PTE comprises a field representing a number of PTEs in the operation.

19. The computer system according to claim 18, further comprising identifying the first PTE of the first operation according to the field of the PTE.

20. The computer system according to claim 15, wherein the error data comprises a disable flag, an address of the error, and an error code.
